(19) United States
(12) Patent Application Publication
(10) Pub. No.: US 2026/0168832 A1
(43) Pub. Date: Jun. 18, 2026

(54) MOUNTING TOOL FOR MOUNTING AN INSERTABLE FLOWMETER AND METHOD FOR SETTING UP SUCH A FLOWMETER

(71) Applicant: Endress+Hauser Flowtec AG, Reinach (CH)

(72) Inventor: Martin Barth, Riehen (CH)

(21) Appl. No.: 19/125,397

(22) PCT Filed: Oct. 23, 2023
(86) PCT No.: PCT/EP2023/079409

§ 371 Date: Apr. 29, 2025

(30) Foreign Application Priority Data
Nov. 9, 2022 (DE) 10 2022 129 631.8

(51) Int. Cl. G01F 1/684; G01F 1/58

(52) U.S. Cl. CPC G01F 1/684; G01F 1/58

(57) ABSTRACT

A mounting tool configured to mount a measuring device inserted into a pipe, such as a flowmeter, includes: a receiving device configured to receive a sensor neck of the measuring device; a pointer device configured to indicate an alignment of the mounting tool fastened to the receiving device; and a fastening device, wherein the receiving device includes a body with two end faces that run parallel to one another, and an edge surface connecting the end faces, wherein on at least one of the end faces the body has a first marking configured to be brought into alignment with a second marking of the sensor neck, wherein the pointer device has a laser by which an alignment of the mounting tool can be adjusted.

The invention relates to a mounting tool for mounting and aligning a flowmeter that can be inserted into a pipe and to a method for setting up such a flowmeter.

Typically, such flowmeter tubes have a sensor neck with a marking by means of which an orientation of a sensor of the flow measuring device can be adjusted to an accuracy of a few degrees. DE102017112622A1 discloses an example of such a thermal flowmeter. It has been shown that this relatively coarse setting accuracy is often not sufficient to achieve good measurement accuracy for a parameter being measured.

The object is therefore to achieve a robust and precise alignment of a flowmeter that can be inserted into a pipe.

The object is achieved by a mounting tool according to independent claim 1, by a mounting arrangement to independent claim 13, and by a method according to independent claim 14.

A mounting tool according to the invention designed for mounting a measuring device that can be inserted into a pipe, such as a flowmeter, in particular a thermal or magnetic-inductive flowmeter, comprises:
a receiving device configured to receive a sensor neck of the measuring device,
a pointer device which is configured to indicate an alignment of the mounting tool and is fastened to the receiving device,
a fastening device which is designed to fasten the mounting tool to the sensor neck via at least three contact areas,
wherein the receiving device has a body with two parallel end faces which are in particular identical and arranged one above the other, and an edge surface connecting the end faces, wherein the body has a recess for receiving the sensor neck, wherein the edge surface has at least two of the at least three contact areas,
wherein the body has on at least one of the end faces a first marking which is configured to be brought into alignment with a second marking of the sensor neck,
wherein the pointer device has a laser which is configured to project a light marking, in particular in the form of a point or line, by means of which an alignment of the mounting tool can be adjusted.

In this way, a sensor that can be inserted into a pipe can be brought into alignment precisely and robustly using the mounting tool.

In one embodiment, the fastening device has a screw device with a screw, which screw is designed to press the sensor neck against the contact areas of the edge surface, wherein the screw forms one of the contact areas.

In this way, the mounting tool can be mounted precisely and fixed on the sensor neck.

In one embodiment, the screw has a screw axis, wherein the contact areas of the edge surface are arranged to be axially symmetrical with respect to the screw axis.

In this way, the mounting tool can be positioned even more precisely on the sensor neck.

In one embodiment, the laser is configured to project a linear light marking, wherein the laser has an aperture angle of at least 10 angular degrees in a first plane extending through the light marking for the purpose of projecting the linear light marking, and an aperture angle of less than 1 angular degree in a second plane extending through the laser and perpendicular to the first plane.

In this way, a clearly visible light marking can be created, by means of which alignment inaccuracy can be further minimized. Upon rotation, with an absolute tangential uncertainty of a marking, the longer the pointer, the greater the accuracy with respect to an angular error.

In one embodiment, the body has a first marking on each end face, wherein the first markings are in particular identical in a projection onto a plane passing through one of the end faces.

This simplifies the handling of the mounting tool, since the user always has a first marking in sight.

In one embodiment, the receiving device has at least one of the following materials: metal such as stainless steel, a plastic, a wood, a composite material.

In one embodiment, the receiving device has a surface coating which is in particular hydrophobic.

This ensures long-term mechanical stability of the receiving device.

In one embodiment, a screw tip has a softer material than the sensor neck.

In this way, damage to the sensor neck can be avoided.

In one embodiment, the body is designed, with respect to the contact areas, to envelop the sensor neck over
at least 200 degrees, and in particular at least 210 degrees, and preferably at least 220 degrees
and/or
not more than 260 degrees, and in particular not more than 250 degrees, and preferably not more than 240 degrees
when the mounting tool is positioned on the sensor neck.

In this way, a secure and robust fit of the mounting tool on the sensor neck can be ensured.

In one embodiment, the mounting tool comprises a separate sighting device which is designed to be positioned at a distance greater than 50 centimeters from the pointer device and to provide the light marking with an optimal alignment,
wherein the laser is configured to be directed towards the sighting device.

In one embodiment, the sighting device has a device for checking an in particular horizontal or vertical alignment.

The device for alignment can, for example, have a bubble level, or a shelf or holder for an electronic position measuring device such as a smartphone, or a recess adapted to the sensor neck, wherein the recess can be placed against the sensor neck and is thereby forced into correct alignment. Depending upon the alignment of the sensor neck, a target alignment of the sighting device may also deviate from a horizontal or a vertical.

In one embodiment, a first end, facing the sensor neck, of the first marking is at a distance of at most 5 millimeters and in particular at most 3 millimeters from a wall of the sensor neck in the installed state.

This minimizes the adjustment uncertainty of the mounting tool on the sensor neck.

A mounting arrangement according to the invention comprises:
a pipe for conveying a medium;
a measuring device which can be inserted into the pipe, such as a flowmeter, in particular a thermal or magnetic-inductive flowmeter;
a mounting tool according to any of the preceding claims, which is arranged on a sensor neck of the measuring device for aligning the measuring device with respect to the pipe.

This allows the measuring device to be aligned with respect to the pipe.

In a method according to the invention for setting up a measuring device that can be inserted into a pipe, in particular a flowmeter, preferably a thermal flowmeter, the measuring device comprises the following:
a sensor for providing measurement signals of a flow parameter, in particular with at least two probes, wherein at least one of the probes is designed to heat a medium flowing through the pipe, and wherein at least one of the probes is designed to detect a temperature of the medium,
a housing with an electronic measuring/operating circuit arranged in the housing for operating the probes, for evaluating measurement signals from the probes, and for providing measured values of a parameter,
a sensor neck which connects the sensor to the housing and guides electrical lines between the electronic measuring/operating circuit and the probes, wherein the sensor neck is designed to be guided through an opening in a wall of the pipe and sealed to the wall in a media-tight manner,
wherein, in a first method step, the mounting tool is aligned on the sensor neck and fastened thereto,
wherein, in a second method step, the sensor is guided through the opening in the wall, and the pointer device is aligned for example parallel to a pipe axis,
wherein, in a third method step, the sensor neck is sealed tightly to the wall by means of a closure mechanism.

In one embodiment, the second method step comprises positioning the sighting device before aligning the pointer device.

The invention will be described in the following with reference to exemplary embodiments.

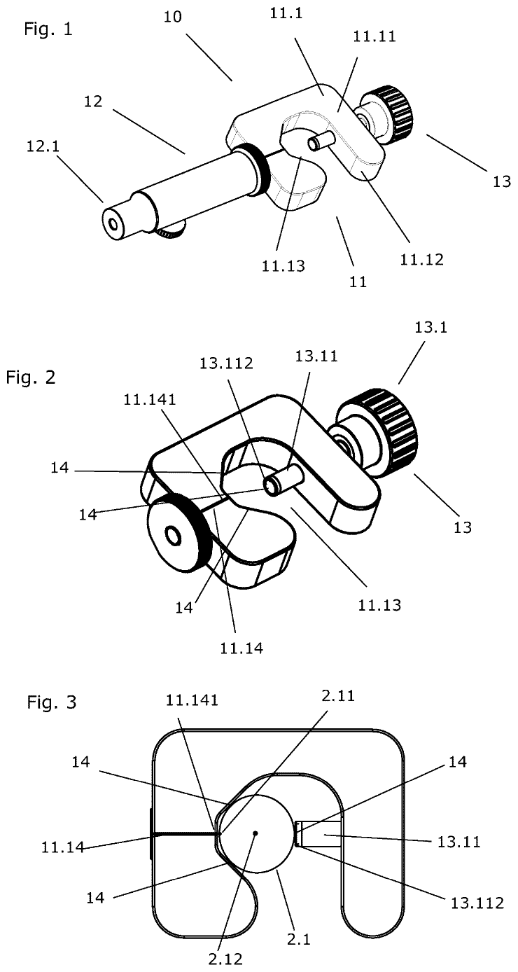

FIG. 1 shows an example of a mounting tool according to the invention;

FIG. 2 shows an enlarged section of the mounting tool shown in FIG. 1;

FIG. 3 shows an enlarged section of the mounting tool shown in FIG. 1, installed on a sensor neck;

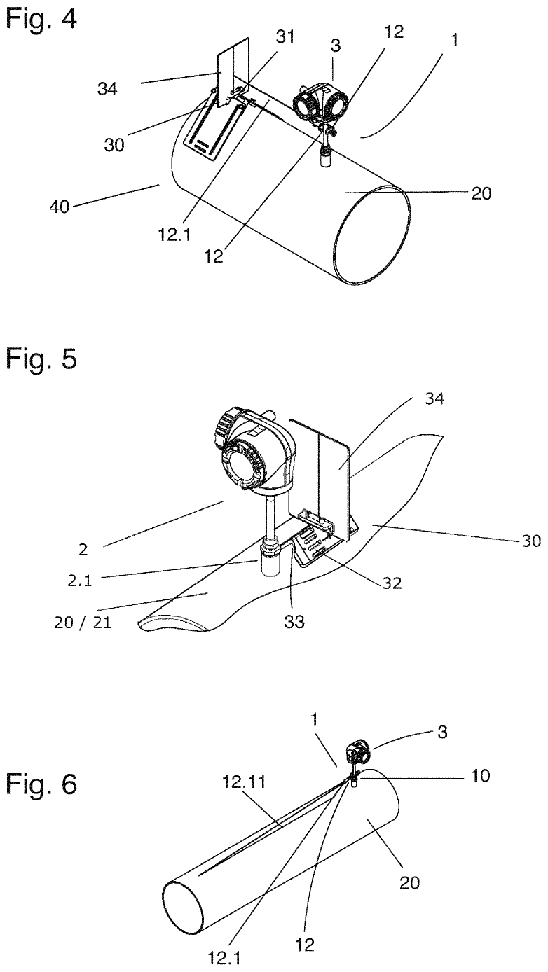

FIG. 4 sketches a mounting arrangement with a measuring device that can be inserted into a pipe and has a sensor neck to which a mounting tool according to the invention is fastened;

FIG. 5 sketches an embodiment of a mounting tool according to the invention;

FIG. 6 sketches a measuring device which can be inserted into a pipe and has a sensor neck to which a mounting tool according to the invention is fastened;

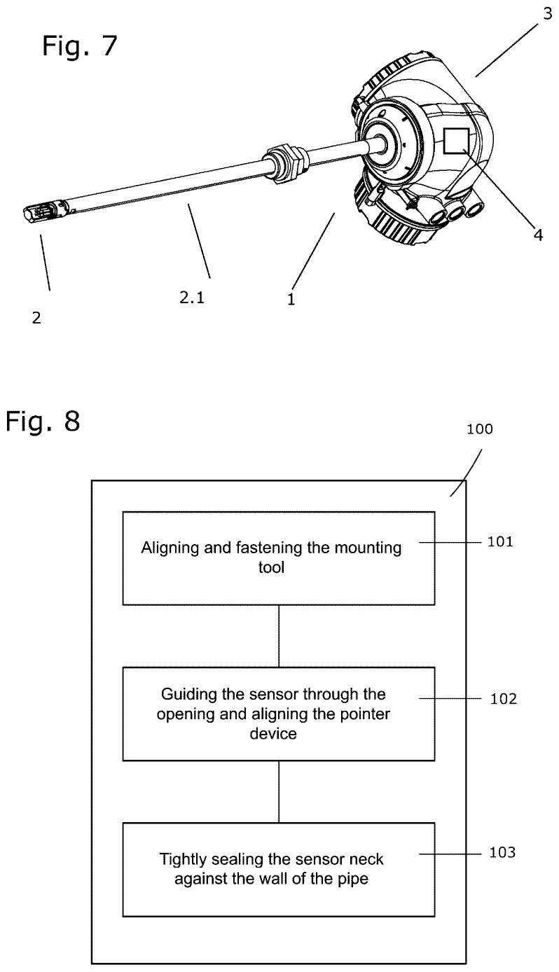

FIG. 7 shows an oblique view of a measuring device that can be plugged into a pipe;

FIG. 8 sketches the sequence of a method according to the invention for setting up a measuring device that can be inserted into a pipe.

FIG. 1 shows a plan view of a mounting tool 10 according to the invention, which comprises a receiving device 11 for receiving a sensor neck 2.1 (not shown here) of a measuring device that can be plugged into a pipe, a pointer device 12 with a pointer 12.1 for aligning the mounting device, and a fastening device 13 for fastening to the sensor neck. The receiving device comprises a body 11.1 with two end faces 11.11 running parallel to each other-here, in particular identical and superimposed—and an edge surface 11.12 connecting the end faces, wherein the body has a recess 11.13 for receiving the sensor neck.

A laser 12.1 of the pointer device is configured to project a light marking, in particular in the form of a point or line, by means of which an alignment of the mounting tool can be adjusted. In this way, a sufficiently accurate alignment of the measuring device can be achieved in a simple manner, since, when rotating with an absolute tangential uncertainty, the pointer positioning becomes increasingly more accurate with increasing length of the pointer with regard to an angular error.

FIG. 2 shows an enlarged section of the mounting tool, shown in FIG. 1, in the region of the receiving device.

According to the invention, the body has on at least one of the end faces 11.11 a first marking 11.14 with a first end 11.141, which first end is designed to be brought into alignment with a second marking 2.11 of the sensor neck 2.1; see in this respect also FIG. 3, which shows an enlarged detail of the mounting tool fastened to a sensor neck 2.1. The fastening device 13 with a screw device 13.1 is designed to fasten the mounting tool to the sensor neck via at least three contact areas 14 (see also FIG. 3) between the mounting tool 10 and the sensor neck 2.11, wherein the edge surface in the region of the recess comprises at least two of the at least three contact areas 14, and wherein a screw tip 13.112 of the screw 13.11 forms a further contact area 14.

In one embodiment, the body 11 is configured with respect to the contact areas 14, when the mounting tool 10 is positioned on the sensor neck, to envelop the sensor neck 2.1 over
at least 200 degrees, and in particular at least 210 degrees, and preferably at least 220 degrees
and/or
not more than 260 degrees, and in particular not more than 250 degrees, and preferably not more than 240 degrees
relative to a center point of the sensor neck.

In this way, a secure fit of the mounting tool on the sensor neck can be ensured when fastening, for example, via three contact areas.

In one embodiment, the screw 13.11 has a screw axis 13.111, wherein the contact areas 14 of the edge surface 11.12 are arranged to be axially symmetrical with respect to the screw axis.

In one embodiment, the screw tip has a softer material than the sensor neck, so that damage to the sensor neck is avoided.

In one embodiment, the body has a first marking on each end face, wherein the first markings are in particular identical in a projection onto a plane passing through one of the end faces. This simplifies the handling of the mounting tool, since the user always has a first marking in sight.

In one embodiment, the receiving device has at least one of the following materials: metal such as stainless steel, a plastic, a wood, a composite material.

In one embodiment, the receiving device has a surface coating which is in particular hydrophobic. This ensures long-term mechanical stability of the receiving device.

In an embodiment of the mounting tool as shown in FIG. 3, the first end 11.141, facing the sensor neck 2.1, of the first marking 11.14 is at a distance of at most 5 millimeters and in particular at most 3 millimeters from a wall of the sensor neck in the installed state. In this way, an alignment error of the mounting tool relative to the sensor neck can be reduced.

FIG. 4 shows a schematic oblique view of a mounting arrangement 40 with a measuring device 1 inserted into a pipe, comprising a housing 3, in which housing an electronic measuring/operating circuit is arranged (see FIG. 6), a sensor for generating measurement signals for a parameter, wherein sensor and housing are connected via a sensor neck 2.1, to which sensor neck an exemplary mounting tool 10 according to the invention is fastened. In this example, the laser 12.1 is configured to produce a point-shaped light marking. As shown, for example, on the pipe 20, a sighting device 30 may be arranged, which indicates a target alignment of the laser by means of a marking on a screen 34 of the sighting device. In this way, the measuring device 1 can be easily aligned. For the purpose of correct, e.g., horizontal, alignment, the sighting device can have an alignment device such as a bubble level 31, or a platform for an electronic position measuring device such as a smartphone, or a recess adapted to the sensor neck, wherein the recess can be placed against the sensor neck, and the sighting device can thus be aligned relative to the sensor neck; see in this regard also FIG. 5.

FIG. 5 sketches an embodiment of the sighting device 30 in which, as here, for example, a footer 32 of the sighting device has a recess 33 which can be fit against a portion of the sensor neck 2.1, so that an alignment relative to an axis of the sensor neck can be achieved. For example, the sighting device can then be brought to a desired or minimum distance from the pointer device using markings.

FIG. 6 sketches an oblique view corresponding to FIG. 4 as an exemplary embodiment of the mounting tool according to the invention, wherein the laser 12.1 is set up to produce a linear light marking 12.11 which has an aperture angle of at least 10 angular degrees in a first plane running through the light marking, and an aperture angle of less than 1 angular degree in a second plane perpendicular to the first plane and running through the laser. In this way, even without a sighting device, a correct alignment of the mounting tool 10 can be detected quite accurately, especially if the pipe has a curved surface, such as in the case of a round measuring tube. In this case, the linear light marking is only straight if it runs parallel to a measuring tube axis.

The insertable measuring device 1 can, for example, be a flowmeter, in particular a thermal or magnetic-inductive flowmeter.

FIG. 7 sketches an exemplary measuring device 1 which can be inserted into a pipe and which is mounted by means of a mounting tool 10 according to the invention as shown in FIGS. 1 to 5. Such a measuring device has a housing 3 for an electronic measuring/operating circuit 4 for operating the measuring device, such an electronic measuring/operating circuit 4, a sensor 2, and a sensor neck, which sensor neck 2.1 connects the sensor to the housing.

FIG. 8 sketches the sequence of an exemplary method according to the invention, wherein, in a first method step 101, the mounting tool is aligned with the sensor neck and fastened thereto, wherein, in a second method step 102, the sensor is guided through the opening in the wall, and the pointer device is aligned in the direction of a target alignment, e.g., parallel to a pipe axis, wherein, in a third method step 103, the sensor neck is sealed tightly to the wall by means of a closure mechanism. A closure mechanism, as indicated by the nut, serves to tightly seal the sensor neck with a wall of the pipe. For example, the sensor can first be guided through the opening in the wall, and then the mounting tool can be placed thereon.

In this way, the sensor of a measuring device can be aligned precisely and securely in the measuring tube.

List of reference signs

| | |
|---|---|
| 1 | Measuring device |
| 2 | Sensor |
| 2.1 | Sensor neck |
| 2.11 | Second marking |
| 2.12 | Center point |
| 3 | Housing |
| 4 | Electronic measuring/operating circuit |
| 10 | Mounting tool |
| 11 | Receiving device |
| 11.1 | Body |
| 11.11 | End face |
| 11.12 | Edge surface |
| 11.13 | Recess |
| 11.14 | First marking |
| 11.141 | First end of the first marking |
| 12 | Pointer device |
| 12.1 | Laser |
| 12.11 | Light marking |
| 13 | Fastening device |
| 13.1 | Screw device |
| 13.11 | Screw |
| 13.111 | Screw axis |
| 13.112 | Screw tip |
| 14 | Contact area |
| 20 | Pipe |
| 21 | Wall |
| 21.1 | Opening |
| 30 | Sighting device |
| 31 | Bubble level |
| 32 | Footer |
| 33 | Recess |
| 34 | Screen |
| 40 | Mounting arrangement |
| 100 | Method |
| 101 | First method step |
| 102 | Second method step |
| 103 | Third method step |

1-15. (canceled)

16. A mounting tool configured for mounting a measuring device, which can be inserted into a pipe, the mounting tool comprising:
a receiving device configured to receive a sensor neck of the measuring device, wherein the receiving device includes a body with two parallel end faces, which are arranged one above the other, and an edge surface connecting the end faces, which edge surface includes at least two of at least three contact areas,
wherein the body includes a recess adapted for receiving the sensor neck, and
wherein at least one of the end faces includes a first marking configured to be brought into alignment with a second marking of the sensor neck;
a fastening device configured to fasten the mounting tool to the sensor neck via at least three contact areas; and
a pointer device fastened to the receiving device and adapted to indicate an alignment of the mounting tool, wherein the pointer device includes a laser configured to project a light marking, in the form of a point or line, by which the alignment of the mounting tool can be adjusted.

17. The mounting tool according to claim 16, wherein the fastening device includes a screw device with a screw configured to press the sensor neck against the at least two contact areas of the edge surface, wherein the screw forms one of the contact areas.

18. The mounting tool according to claim 17, wherein the screw includes a screw axis,
wherein the at least two contact areas of the edge surface are arranged to be axially symmetric with respect to the screw axis.

19. The mounting tool according to claim 17, wherein the screw includes a screw tip composed of a softer material than the sensor neck.

20. The mounting tool according to claim 16, wherein the laser is configured to project a linear light marking,
wherein, to facilitate the projecting of the linear light marking, the laser has a first aperture angle of at least 10 angular degrees in a first plane passing through the light marking and has a second aperture angle of less than 1 angular degree in a second plane passing through the laser, which second plane is perpendicular to the first plane.

21. The mounting tool according to claim 16, wherein the body includes a first marking on each end face, wherein the first markings are identical in a projection onto a plane passing through one of the end faces.

22. The mounting tool according to claim 16, wherein the receiving device includes at least one of the following materials: metal, a plastic, a wood, and a composite material.

23. The mounting tool according to claim 22, wherein the receiving device includes a stainless steel.

24. The mounting tool according to claim 16, wherein the receiving device includes a surface coating, which is hydrophobic.

25. The mounting tool according to claim 16, wherein the body is configured relative to the at least three contact areas to envelop the sensor neck over at least 200 degrees, and/or not more than 260 degrees, when the mounting tool is fastened to the sensor neck.

26. The mounting tool according to claim 25, wherein the body is configured relative to the at least two contact areas to envelop the sensor neck over at least 220 degrees and/or not more than 240 degrees.

27. The mounting tool according to claim 16, further comprising a sighting device configured to be positioned at a distance greater than 20 centimeters from the pointer device and to provide an optimal alignment of the light marking,
wherein the laser is configured to be aligned in a direction of the sighting device.

28. The mounting tool according to claim 27, wherein the sighting device includes a device for alignment with respect to a horizontal or a vertical axis or with respect to the sensor neck.

29. The mounting tool according to claim 16, wherein a first end of the first marking, which faces the sensor neck is at a distance of at most 5 millimeters when the mounting tool is fastened to the sensor neck.

30. A mounting arrangement, comprising:
a pipe configured to convey a medium;
a measuring device insertable into the pipe; and
a mounting tool according to claim 16, which is arranged on a sensor neck of the measuring device to enable aligning the measuring device with respect to the pipe.

31. A method for installing a measuring device configured to be inserted into a pipe, wherein the measuring device comprises:
a sensor configured to generate measurement signals of a flow parameter of a medium, the sensor including at least two probes, wherein at least one of the probes is operable to heat the medium flowing through the pipe, and wherein at least one of the probes is operable to detect a temperature of the medium;
a housing with an electronic measuring/operating circuit arranged therein and configured to operate the sensor and the at least two probes, to evaluate the measurement signals from the sensor, and to provide measured values of the flow parameter; and
a sensor neck adapted to connect the sensor to the housing and guide electrical lines between the electronic measuring/operating circuit and the at least two probes, wherein the sensor neck is configured to be introduced through an opening in a wall of the pipe and sealed to the wall in a media-tight manner,
the method comprising:
aligning a mounting tool according to claim 16 on the sensor neck and fastening the mounting tool thereto;
introducing the sensor through the opening in the wall such that the pointer device is aligned in a direction of a target alignment; and
sealing the sensor neck media-tightly to the wall by a closure mechanism.

32. The method according to claim 31, wherein the target alignment is parallel to a longitudinal axis of the pipe.

33. The method according to claim 31, wherein the aligning of the pointer device comprises aligning a sighting device before positioning the pointer device, wherein the sighting device is configured to be positioned at a distance greater than 20 centimeters from the pointer device and to provide an optimal alignment of the light marking.

34. The mounting tool according to claim 16, wherein the measuring device is a thermal flowmeter or magnetic-inductive flowmeter.

35. The method according to claim 31, wherein the measuring device is a thermal flowmeter or magnetic-inductive flowmeter.
